(19) United States
(12) Patent Application Publication
(10) Pub. No.: US 2007/0110937 A1
(43) Pub. Date: May 17, 2007

(54) Reinforcing strip with barrier layer for flexible pipes

(75) Inventors: Erwin Lokere, Hooglede (BE); Luc Bourgois, Desselgem (BE)

Correspondence Address: FOLEY AND LARDNER LLP;SUITE 500, 3000 K STREET NW, WASHINGTON, DC, 20007, US

(73) Assignee: NV Bekaert SA

(21) Appl. No.: 10/582,078

(22) PCT Filed: Oct. 4, 2004
(86) PCT No.: PCT/EP04/52414

§ 371 Date: Jun. 8, 2006

(30) Foreign Application Priority Data
Dec. 8, 2003 (EP) 03104577.6

(51) Int. Cl. B32B 1/08

(52) U.S. Cl. 428/36.9

(57) ABSTRACT

A strip (10) for use in manufacturing a flexible pipe or tube (30) comprises a thermoplastic matrix (12) with reinforcing elements (14) and further comprises a barrier layer (16, 18, 20), which is bonded to the thermoplastic matrix (12). The strip provides the two functions of both reinforcement and barrier and allows simplifying the way of manufacturing a flexible pipe or tube.

### FIELD OF THE INVENTION

The present invention relates to a strip for use in manufacturing a flexible pipe or tube or hose.

### BACKGROUND OF THE INVENTION

Flexible pipes, tubes or hoses are known. These pipes, tubes or hoses may be made of a thermoplastic material such as polyethylene, medium-density polyethylene (MDPE) or high-density polyethylene (HDPE). In what follows, reference will only be made to pipes, but the teaching may also be applicable to tubes or hoses.

The pipes may be used for transport of all sorts of gases or liquids. Preferably the pipes have a degree of impermeability to gases or to liquids.

One of the reasons therefore is that blistering is to be avoided. Blistering is the occurrence of fractures due to the existence of voids inside the pipe, the presence of gas in the void and the building up of pressure inside the voids until fracture.

Another reason is that when water is allowed to penetrate into the thermoplastic matrix material, this thermoplastic matrix material may loose some of its isolation functions.

The required degree of impermeability may be obtained by applying a continuous metal layer to the inner part of the pipe, for example by means of vapor deposition of aluminum on the extruded cylindrical inner core of the flexible pipe or by winding an aluminum foil helically around the inner core of the flexible pipe. The step of vapor deposition or the step of winding, however, adds to the cost and complexity of the process of manufacturing a flexible pipe.

### SUMMARY OF THE INVENTION

It is an object of the present invention to avoid the drawbacks of the prior art.

It is also an object of the present invention to allow for a simplified way of manufacturing a flexible pipe.

It is another object of the present invention to minimize the number of steps in the manufacturing of a flexible pipe with a degree of impermeability.

According to a first aspect of the present invention, there is provided a strip for use in manufacturing a flexible pipe, tube or hose. The strip comprises a thermoplastic matrix having reinforcing elements. The strip further comprises a barrier layer, which is bonded to the thermoplastic matrix.

DE 24 24 207 discloses a flexible laminate, amongst others for making a pipe. The laminate has a body layer constituted by a fibre reinforced matrix of thermoplastic resin. The laminate further comprises a layer made of polyamide. The purpose of this polyamide layer, however, is not to function as a barrier layer.

Within the context of the present invention, the terms “barrier layer” means a barrier layer, which is more impermeable than the thermoplastic matrix comprising the reinforcing elements. The degree of permeability is measured by the amount of particles or molecules of the gas or liquid to be transported, which passes through the material per unit of time. Within the context of the present invention, the thermoplastic matrix is e.g. two times, e.g. three times or more permeable than the barrier layer.

Instead of applying a barrier layer to the inner core of a flexible pipe, the invention already provides the barrier layer to a strip, which will be used to manufacture the flexible pipe. This additional function of the strip allows eliminating the step of rendering the inner core of the flexible pipe impermeable when manufacturing the flexible pipe.

The reinforcing elements may be high-strength synthetic fibers or yarns with high-strength synthetic fibers. Preferably, the reinforcing elements are elongated metal elements such as steel wires or steel cords.

In one embodiment of the present invention, the barrier layer is formed by a thermoplastic material and is co-extruded or co-laminated with the thermoplastic matrix to form the invention strip. An adhesive layer or primer may be present between the thermoplastic matrix and the barrier layer.

The thermoplastic material of the barrier layer may be selected from a group consisting of fluoropolymers, polyethylene vinyl alcohol, polyamides, polyesters, polymers with liquid crystals such as disclosed in WO-A-01/98072, halogenids of polyvinylidene, polyacrylonitriles, . . . . .

Within this group, the fluoropolymers have particularly proved to provide an adequate barrier layer, although they are not 100% impermeable. The term “fluoropolymers” refers to both fully fluorinated polymers and to fluoropolymers or copolymers which are not necessarily fully fluorinated and which comprise an ethylene group or an alkoxyl group. The terms “fully fluorinated polymers” refer to fluoropolymers where a fluor atom replaces all hydrogen atoms in a carbon-hydrogen bond. Such fluoropolymers are chemically inert and have both low and high temperature stability. Examples of fluoropolymers are FEP, PFA, PTFE, ETFE and PVDF.

In another embodiment of the present invention, a continuous metal layer bonded to the thermoplastic matrix material forms the barrier layer. This bonding may be done by laminating the continuous metal layer to the thermoplastic matrix, for example with the help of a primer layer, an adhesion promoter or an adhesive resin.

A continuous metal layer may also be created on the thermoplastic matrix by vacuum depositing one or more initial layers on the thermoplastic matrix material, possibly followed by a thickening of the initial layers by means of a more economical electrolytic deposition method. Suitable metals are aluminum, nickel and also AlOₓ and SiOₓ where x is smaller than two. Aluminum, AlOₓ and SiOₓ have proved to provide a very effective barrier layer. AlOₓ and SiOₓ are particularly useful, since they can withstand better elongations than pure aluminum. Evaporated AlOₓ can withstand elongations up to 3% à 4% and SiOₓ can withstand elongation of up to 7 percent and still provide the barrier function. With a barrier layer out of aluminum this is only possible for elongations up to 1 percent.

An advantageous embodiment of the present invention is formed by strip where the width of the thermoplastic matrix material is smaller than the width of the barrier layer.

The barrier may then have one or two zones, which are not supported or bonded, to the thermoplastic matrix. When manufacturing the flexible pipe, this strip is then helically wound around a core of the pipe so that the thermoplastic matrix part forms a closed layer along the length of the flexible pipe. The barrier layer then necessarily overlaps with the strip and the barrier layer of a neighboring winding so that a higher degree of impermeability is obtained.

According to a second aspect of the present invention, there is provided a flexible pipe, tube or hose comprising at least one helically wound strip according to the first aspect of the present invention.

According to a third aspect of the present invention, there is provided a method of manufacturing a flexible pipe or tube. This manufacturing method comprises the steps of:
a) providing a cylindrical core;
b) providing a thermoplastic matrix strip;
c) bonding a barrier layer to the thermoplastic matrix strip;
d) helically winding the thermoplastic matrix strip with the barrier layer around the cylindrical core.

This method of manufacturing avoids the step of applying a barrier layer to the inner side of the flexible pipe or tube.

### BRIEF DESCRIPTION OF THE DRAWINGS

The invention will now be described into more detail with reference to the accompanying drawings wherein

FIG. 1 shows a cross-section of strip with a thermoplastic barrier layer;

FIG. 2 shows a cross-section of another embodiment of a strip with a thermoplastic barrier layer;

FIG. 3 shows a cross-section of a strip with a metal barrier layer;

FIG. 4 shows a cross-section of another embodiment of a strip with a metal barrier layer;

FIG. 5 shows a cross-section of still another embodiment of a strip with a metal barrier layer;

FIG. 6 gives a schematic view of a flexible pipe and some of its components.

### DESCRIPTION OF THE PREFERRED EMBODIMENTS OF THE INVENTION

### Example 1

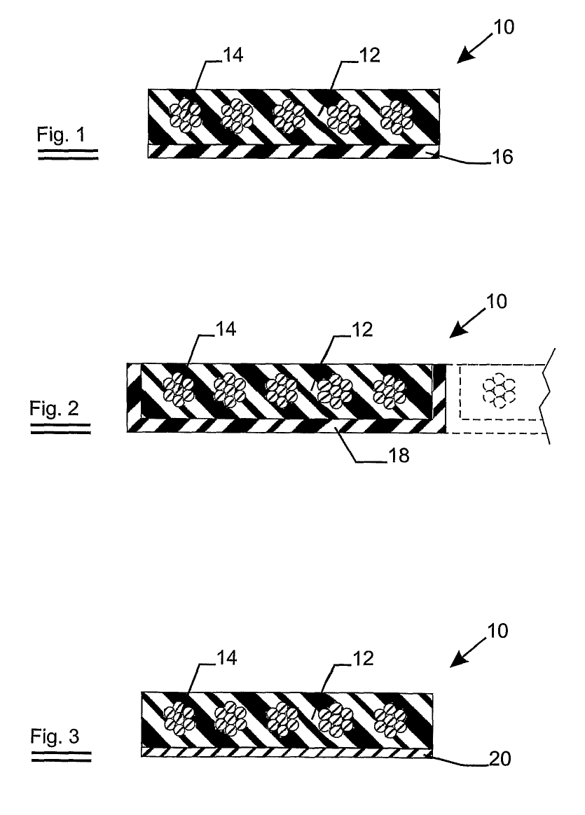

FIG. 1 is a cross-section of a strip 10 with a thermoplastic matrix 12 and with steel cords 14 as reinforcing elements embedded and anchored in the matrix 12. The strip 10 is also provided with a barrier layer 16 of polyethylene vinyl alcohol, which has been co-extruded with the thermoplastic matrix 12 of HDPE. A modified polyethylene intermediate layer may improve the adhesion between the HDPE and the polyethylene vinyl alcohol.

In an alternative embodiment the barrier layer 16 may be laminated to the thermoplastic matrix 12.

The width of the strip is 123.6 mm and the thickness is 1.6 mm.

More generally and depending upon the diameter of the inner liner, the width of the strip may vary from 40 mm to 200 mm and more, and the thickness may vary from 0.8 mm to 3.0 mm and more.

### Example 2

FIG. 2 is a cross-section of another embodiment of a strip 10 with a thermoplastic barrier layer. The thermoplastic barrier layer 18 has the form of a U. The thermoplastic barrier layer 18 has a width, which is greater than the width of the thermoplastic matrix 12. The barrier-layer 18 encloses for a great part the thermoplastic matrix 12 and avoids—or at least decreases—gas or liquid penetration to the thermoplastic matrix 12 and to the steel reinforcing elements 14. A neighboring winding of the strip is shown in hatched lines.

A modified polyolefin may improve the adhesion between the thermoplastic barrier layer 18 and the thermoplastic matrix.

### Example 3

FIG. 3 is a cross-section of a strip 10 provided with a barrier layer 20 out of metal such as aluminum. The aluminum barrier layer 20 has been co-laminated to the matrix material 12, e.g. by means of an adhesion promoter such as a silane. A silane cross-linkable HDPE can be used as thermoplastic matrix material 12.

### Example 4

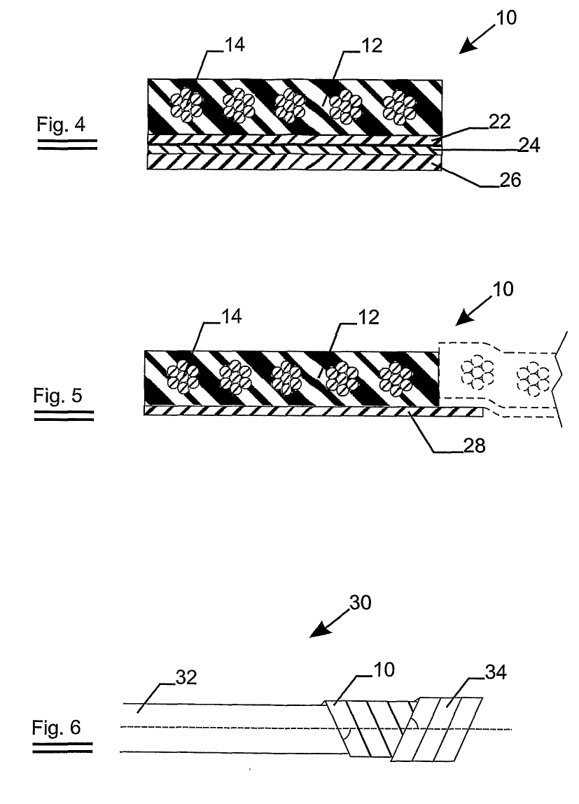

FIG. 4 is a cross-section of a strip 10, which is also provided with a barrier layer out of metal. Upon the thermoplastic matrix an initial tie or adhesion layer 22 such as chromium is vacuum deposited. Upon the tie layer 22 comes a vacuum deposited seed layer 24 out of nickel. The final layer 26 is also a nickel layer deposited, however, through an electrolytic way. It is hereby understood that the electrolytic way of deposition is more economic than the vacuum deposition. Vacuum deposition is used to obtain the required level of adhesion and the electrolytic deposition is used to obtain the required degree of thickness, and hence the required degree of impermeability.

### Example 5

FIG. 5 is a cross-section of a preferable embodiment of the strip of the present invention. The strip 10 is provided with a metal barrier layer 28 bonded to the thermoplastic matrix 12 by means of a co-lamination process and with the help of an adhesion primer. The width of the barrier layer 28 is greater than the width of the thermoplastic matrix 12 so that a zone is created in the barrier layer 28, which is not supported by the thermoplastic matrix 12. When manufacturing the flexible pipe, more particularly when winding such a strip helically around the core of a flexible pipe with the barrier layer radially inward, the not-supported and protruding zone creates a zone of overlap with the next winding of the strip so as to increase the degree of impermeability and to decrease the speed of penetration. A neighboring winding of the strip is shown in dotted lines.

FIG. 6 gives a schematical view of a flexible pipe 30. The flexible pipe 30 comprises a thermoplastic cylindrical core 32 around which is wound a strip 10 according to the first aspect of the present invention. This strip 10 forms a predetermined angle α, e.g. 50°, with the axis of the flexible pipe. When winding the strip 10 around the core 32 of the flexible pipe 30, the barrier layer must be situated radially inward. Another reinforcing strip 34, not necessarily with a barrier layer, is wound in the other direction, i.e. forming an angle of −50° with the axis, on the layer of the wound strip 10.

1. A strip for use in manufacturing a flexible pipe or tube, said strip comprising a thermoplastic matrix with reinforcing elements, characterized in that said strip further comprises a barrier layer, said barrier layer being bonded to said thermoplastic matrix.

2. A strip according to claim 1, wherein said reinforcing elements are elongated metal elements such as steel wires or steel cords.

3. A strip according to claim 1, wherein said barrier layer is of a thermoplastic material, which is co-extruded or co-laminated with said thermoplastic matrix.

4. A strip according to claim 3, wherein said thermoplastic material of said barrier layer is selected of a group consisting of fluoropolymers, polyethylene vinyl alcohol, polyamides, polymers with liquid crystals, halogenides of polyvinylidene, polyacrylonitriles, and the like.

5. A strip according to claim 1, wherein said barrier layer is a continuous metal layer.

6. A strip according to claim 5, wherein said continuous metal layer has been laminated on said thermoplastic matrix.

7. A strip according to claim 5, wherein said continuous metal layer has been vacuum deposited on said thermoplastic matrix.

8. A strip according to claim 1, said thermoplastic matrix having a matrix width, said barrier having a barrier width, said barrier width exceeding said matrix width so that said barrier has one or two zones which are not bonded to said matrix.

9. A strip according to claim 8, wherein said strip barrier has only one zone which is not bonded to said matrix.

10. A strip according to claim 1, wherein said thermoplastic matrix at the side opposite to said barrier layer has been modified or is provided with a tie layer for promoting the adhesion with the material of the flexible pipe or tube.

11. A flexible pipe or tube comprising a strip according to claim 1.

12. A method of manufacturing a flexible pipe or tube, said method comprising the steps of:
a) providing a cylindrical core;
b) providing a thermoplastic matrix strip;
c) bonding a barrier layer to said thermoplastic matrix strip;
helically winding said thermoplastic matrix strip with said barrier layer around said cylindrical core.
